(19) United States
(12) Patent Application Publication
(10) Pub. No.: US 2005/0042382 A1
(43) Pub. Date: Feb. 24, 2005

(54) Method for roller-coating rough surfaces

(76) Inventors: Philip James Palfrey, High Wycombe (GB); Arthur Vaughan Rees, Westbury (GB)

Correspondence Address: MORGAN LEWIS & BOCKIUS LLP, 1111 PENNSYLVANIA AVENUE NW, WASHINGTON, DC, 20004, US

(21) Appl. No.: 10/488,755

(22) PCT Filed: Sep. 4, 2002
(86) PCT No.: PCT/EP02/10034

(30) Foreign Application Priority Data
Sep. 14, 2001 (GB) 0122284.3

(51) Int. Cl. B05C 1/00; A47L 1/00; B05C 17/02

(52) U.S. Cl. 427/428.01; 118/200; 15/230.11

(57) ABSTRACT

A method for roller coating rough surfaces such as those on sawn wood used in garden fences and decking. The method employs coating compositions of a particular high viscosity and applies them using a roller (1) having an outer sleeve (3) provided with long fibres and preferably surrounding a resiliently compressible inner sleeve (4). The combination of high viscosity compositions and long fibres enables efficient coating of rough surfaces. Also for use in the method, a roller having a resilient inner sleeve.

This invention relates to a method for roller coating rough surfaces.

Rough surfaces are frequently found on sawn wood structures such as garden fences or decking. The surfaces are characterised by numerous irregular recesses all of which have to be coated if the entire surface is to be covered uniformly. Hitherto, the coating of such recesses has required the use of a brush and very fluid coating compositions whose mid-shear and high shear viscosities are as low as 0.08 Pa.sec at 20° C. and 0.025 Pa.sec at 25° C. respectively. Such low viscosity coating compositions are too fluid for application by paint rollers. As compared with brush-application, roller application is quite quick and so the inability to use rollers in coating rough surfaces means that the coating of such surfaces is a slower process than would be the case if rollers could be used.

One of the objects of this invention is to provide a method for coating rough surfaces which can use a roller as the application tool. Another object is to provide a roller for use in the method.

Accordingly this invention provides a method for applying a coating composition onto a rough surface using a roller having an outer sleeve provided with fibres extending outwardly from the sleeve wherein the coating composition has a Rotothinner mid-shear viscosity at 20° C. of at least 5 Pa.sec (Pascal.second) and an ICI Cone & Plate high shear viscosity at 25° C. of at least 0.03 Pa.sec and the fibres have a length of at least 3 mm and preferably from 7 to 25 mm. It has been found that the use of very high viscosity coating compositions in combination with a roller having long fibres allows the compositions to be forced into recesses of the type found on sawn wood of the type used in making garden fences and decking. Preferably the Rotothinner mid-shear viscosity lies in the range 60 to 130 Pa.sec and the ICI Cone & Plate viscosity lies in the range 0.07 to 0.1 Pa.sec. The outer sleeve is preferably made from sheepskin, or woven or knitted polyester, polyamide or woollen fabrics.

Improved coating can be achieved if the outer sleeve is carried on a resiliently compressible inner sleeve. The compressible inner sleeve is preferably formed from a foamed material such as foamed polyurethane, foamed neoprene, foamed butadiene-styrene rubber or foamed polyethylene or ethylene-vinyl acetate copolymer including crosslinked polyethylene or its crosslinked copolymers. Preferably the density of the foamed material is from 50 to 80% of that of the unfoamed material.

Conventionally, rollers are used mounted on a central axle attached to a handle so that in use, the roller has a proximal end attached to the handle and a distal end remote from the handle. In order to coat overlapping panels efficiently, it is preferred to extend the outer sleeve around the distal end of the roller attached to a handle.

A preferred roller for use in this invention will now be described with reference to the drawings in which

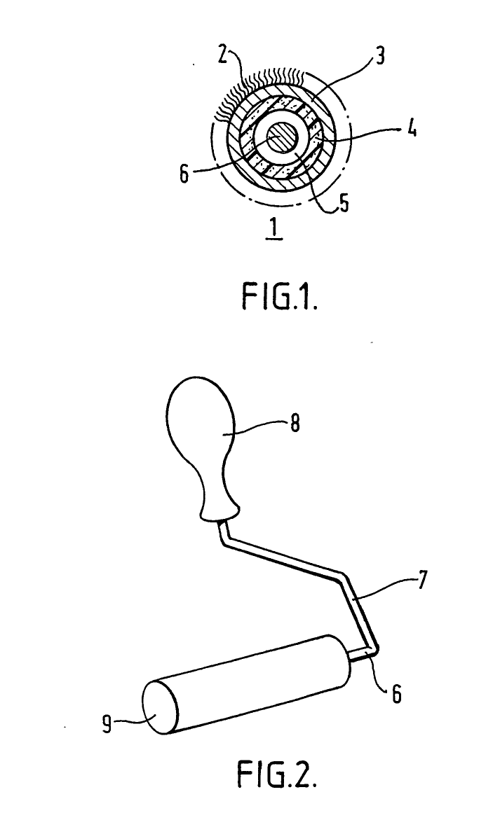

FIG. 1 is a transverse section through a roller according to this invention and

FIG. 2 shows on a smaller scale, a perspective view of the roller shown in FIG. 1 when attached to handle.

FIG. 1 shows a roller 1 having fibres 2 extending essentially radially outwardly from an outer sleeve 3 which surrounds a resiliently compressible foamed inner sleeve 4 mounted on a support 5 which in turn is rotatably mounted on an axle 6.

From FIG. 2, it can be seen that axle 6 is rigidly connected to a handle 7 by shaped metal bar 8. Outer sleeve 3 extends around distal end 9 of roller 1 so as to facilitate the coating of overlapping panels.

This invention also provides a roller for use in the method of this invention which roller has an outer sleeve provided with fibres extending outwardly from the sleeve wherein the fibres have a length of at least 3 mm and preferably from 7 to 25 mm and the outer sleeve surrounds a resiliently compressible inner sleeve.

For the purposes of this invention, ICI Cone & Plate high shear viscosity is determined at 25° C. as follows:

Fixed shear-rate viscosity is measured using the cone and plate technique described in ASTM Test D4287-87, but with conditions adapted to produce a shear rate of 10,000/sec. The cone has an angle of 0.5° and a radius of 7.5 mm.

Rotothinner mid-shear viscosity is determined at 20° C. using the Sheen/ICI Rotothinner (Electrical Model) described in the Sheen leaflet headed “Viscosity Sheen” published by Sheen Instruments Limited of Kingston on Thames, Surrey, England.

1. A method for applying a coating composition onto a rough surface using a roller having an outer sleeve provided with fibres extending outwardly from the sleeve wherein the coating composition has a Rotothinner mid-shear viscosity at 20° C. of at least 5 Pa.sec and an ICI Cone & Plate high shear viscosity at 25° C. of at least 0.03 Pa.sec and the fibres have a length of at least 3 mm.

2. A method according to claim 1 wherein the length of the fibres is from 7 to 25 mm.

3. A method according to claim 1 or claim 2 wherein the outer sleeve is carried on a resiliently compressible inner sleeve.

4. A method according to claim 3 wherein the inner sleeve is formed from a foamed material.

5. A method according to claim 2 wherein the density of the foamed material is from 50 to 80% of the density of the material when unfoamed.

6. A method according to any one of the preceding claims wherein the outer sleeve of the roller extends around one end of the roller.

7. A roller for use in the method of this invention which roller has an outer sleeve provided with fibres extending outwardly from the sleeve wherein the fibres have a length of at least 3 mm and the outer sleeve surrounds a resiliently compressible inner sleeve.

8. A roller according to claim 5 wherein the inner sleeve is formed from a foamed material.

9. A roller according to claim 8 wherein the density of the foamed material is from 50 to 80% of the density of the material when unfoamed.

10. A roller according to any one of claims 7 to 9 wherein the outer sleeve extends around one end of the roller.
